(19) United States
(12) Patent Application Publication
(10) Pub. No.: US 2015/0293711 A1
(43) Pub. Date: Oct. 15, 2015

(54) APPARATUS AND METHOD FOR ALLOCATING DATA PROCESSING BETWEEN TRANSFER SOURCE AND DESTINATION DEVICES

(71) Applicant: FUJITSU LIMITED, Kawasaki-shi (JP)

(72) Inventors: Junji Yamamoto, Yokohama (JP); Taichi KIMURA, Inagi (JP); Hiroyuki KANEKO, Sagamihara (JP); Takahiro TANAKA, Kawasaki (JP); Shuichi Kido, Tagata (JP); Junji Shimaoka, Yokohama (JP); Hideyuki SAITO, Kawasaki (JP)

(73) Assignee: Fujitsu Limited, Kawasaki (JP)

(21) Appl. No.: 14/668,247

(22) Filed: Mar. 25, 2015

(30) Foreign Application Priority Data
Apr. 14, 2014 (JP) 2014-083060

(51) Int. Cl. G06F 3/06

(52) U.S. Cl. CPC G06F 3/0613; G06F 3/065; G06F 3/067

(57) ABSTRACT

In a case of executing, on transfer data which is to be transferred from a first information processing device to a second information processing device, data processing that complies with a data storage format in the second information processing device, a transfer control device determines, as a target information processing device for executing the data processing, one of the first and second information processing devices, based on information on the data processing which includes a variation characteristic of data amount before and after the data processing.

### CROSS-REFERENCE TO RELATED APPLICATION

This application is based upon and claims the benefit of priority of the prior Japanese Patent Application No. 2014-083060, filed on Apr. 14, 2014, the entire contents of which are incorporated herein by reference.

### FIELD

The embodiments discussed herein are related to apparatus and method for allocating data processing between transfer source and destination devices.

### BACKGROUND

In the past, data which is stored in a first information processing device, has been transferred to a second information processing device. In the second information processing device, data conversion is executed with respect to the transferred data, and data storage is performed by a format which is different from the first information processing device.

Japanese Laid-open Patent Publication No. 2007-86883 is an example of the related art.

### SUMMARY

According to an aspect of the invention, in a case of executing, on transfer data which is to be transferred from a first information processing device to a second information processing device, data processing that complies with a data storage format in the second information processing device, an apparatus determines, as a target information processing device for executing the data processing, one of the first and second information processing devices, based on information on the data processing which includes a variation characteristic of data amount before and after the data processing.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a configuration of a transfer control device and a storage server, according to an embodiment;

FIG. 2 is a diagram illustrating an example of a data conversion application information table, according to an embodiment;

FIG. 3 is a diagram illustrating an example of a data conversion application actual result table, according to an embodiment;

FIG. 4 is a diagram illustrating an example of a load information table, according to an embodiment;

FIG. 5 is a diagram illustrating an example of a configuration of a computer which functions as a transfer control device, according to an embodiment;

FIG. 6 is a diagram illustrating an example of an operational flowchart for data conversion execution server determination processing, according to a first embodiment;

FIG. 7 is a diagram illustrating an example of an operational flowchart for data conversion execution server determination processing, according to a first embodiment;

FIG. 8 is a diagram illustrating an example of an operational flowchart for data conversion execution server determination processing, according to a first embodiment;

FIG. 9 is a schematic diagram illustrating an example of a transfer time and a conversion time, according to an embodiment;

FIG. 10 is a diagram illustrating an example of an operational flowchart for data conversion execution server determination processing, according to a second embodiment;

FIG. 11 is a diagram illustrating an example of an operational flowchart for data conversion execution server determination processing, according to a second embodiment; and

FIG. 12 is a schematic diagram illustrating an example of a transfer time and a conversion time, according to an embodiment.

### DESCRIPTION OF EMBODIMENTS

When an amount of data which is transferred between the information processing devices increases, time required for the data transfer may also increase. In order to suppress increase in time to be used for the data transfer, and improve efficiency of the data transfer, it is desirable to decrease the amount of data to be transferred. By performing data processing, such as data conversion, on data, the amount of the data may be changed, and, for example, the amount of the data at the time of the transfer may be reduced.

In the related art, the data conversion is equally performed by a second information processing device to which the data is transferred, and thus, the data amount at the time of the transfer may not be reduced, and the efficiency improvement of the data transfer may not be achieved.

First, problems in data transfer which is accompanied with data processing between information processing devices, will be described before describing details of each embodiment.

For example, in a case of performing the data transfer which is accompanied with the data conversion between a plurality of servers, it is assumed that a dedicated data conversion server is arranged, which intensively executes the data conversion at the time of the data transfer between the servers.

In this case, the data is transferred to a transfer destination server from a transfer source server by way of the data conversion server. Therefore, when an amount of transferred data is small, a large problem does not occur, but when the amount of transferred data is large, the transfer time increases by going through an extra transfer path. Additionally, in order to convert the data, a disk area for temporarily storing the data has to be arranged in the data conversion server. However, when the amount of transferred data is large, the disk area has to be acquired in a large size, and a cost of hardware resources also increases.

Moreover, as the related art described above, in a case of equally performing the data conversion by the transfer destination server, it is not possible to improve efficiency of the data transfer in consideration of the data conversion. For example, when contents of the data conversion is specified by the transfer source server, and the data amount decreases by the data conversion, efficiency improvement of the data transfer is achieved in a case that the data is transferred to the transfer destination server after performing the data conversion by the transfer source server.

However, data conversion in data transfer may have a plurality of types, and variation in amount of data before and after conversion of the data is changed according to a type of the data conversion. For example, when the data conversion is compression processing of the data, since the data amount decreases after the data conversion, efficiency in data transfer becomes better when data is transferred to a transfer destination server after performing the data conversion by a transfer source server. Moreover, when the data conversion is the processing of converting the data of a comma-separated values (CSV) format into the data of an extensible markup language (XML) format, data amount increases after the data conversion. Therefore, efficiency in data transfer becomes better when data conversion is performed by a transfer destination server after the data is transferred to the transfer destination server. In this manner, since a mode of improving the efficiency of data transfer is changed according to a type of data conversion, it is difficult to categorically determine one of the transfer source server and the transfer destination server as a server which executes the data conversion.

Additionally, when the data conversion is performed by the transfer source server, it is necessary for the transfer source server to specify a format in which the transferred data is stored in the transfer destination server.

In consideration of the problems described above, in the embodiment, a server which executes the data conversion is properly determined, depending on the contents of the data conversion to be executed.

Hereinafter, examples of the embodiments according to technologies discussed herein, will be described in detail, with reference to the drawings.

### First Embodiment

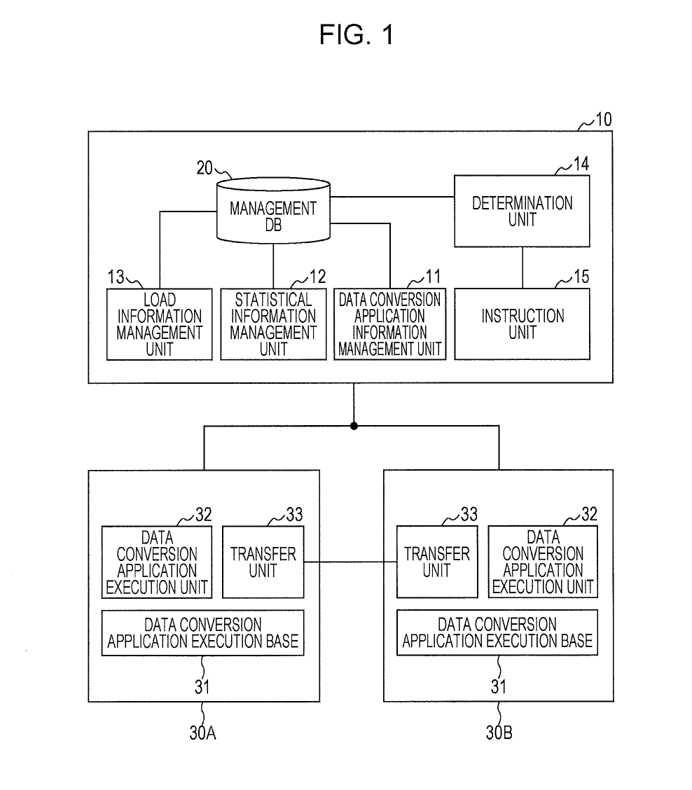

As illustrated in FIG. 1, a transfer control device 10 according to a first embodiment, is connected to a plurality of storage servers 30A and 30B, and controls the data transfer which is accompanied with the data conversion, between the storage server 30A and the storage server 30B. In FIG. 1, a case of two storage servers is exemplified, but the number of storage servers is not limited to two, and may be three or more. In the following description, in a case of describing the storage server 30A and the storage server 30B without distinction, the storage server 30A and the storage server 30B will be referred to as “storage server 30”. Moreover, the storage server 30 which becomes a transfer source of the data transfer, is referred to as “transfer source server S”, and the storage server 30 which becomes a transfer destination, is referred to as “transfer destination server R”.

As illustrated in FIG. 1, the transfer control device 10 includes a data conversion application information management unit 11, a statistical information management unit 12, a load information management unit 13, a determination unit 14, an instruction unit 15, and a management database (DB) 20.

The data conversion application information management unit 11 manages an application (referred to as “data conversion application”, hereinafter) for executing the data conversion which is accompanied with the data transfer between the storage servers 30, and meta information which is accompanied with the data conversion application. The meta information includes a name of the data conversion application, and a characteristic of the data conversion application.

The characteristic of the data conversion application is a characteristic indicating variation in data amount before and after the data conversion executed by the data conversion application. In the first embodiment, as a characteristic of the data conversion application, a Before characteristic, an After characteristic, and an Any characteristic are used.

The Before characteristic is a characteristic representing that the efficiency becomes better when the transfer source server S performs the data conversion, such as a case where the data amount decreases after the data conversion. For example, the characteristic of the data conversion application which executes the compression processing, is the Before characteristic.

The After characteristic is a characteristic representing that the efficiency becomes better when the transfer destination server R performs the data conversion, such as a case where the data amount increases after the data conversion. For example, the characteristic of the data conversion application which executes a conversion from the data of the CSV format to the data of the XML format, is the After characteristic.

The Any characteristic is a characteristic representing that the efficiency does not change largely regardless whether any one of the transfer source server S and the transfer destination server R performs the data conversion, such as a case where variation in data amount is small after the data conversion or the variation is undefined. For example, the characteristic of the data conversion application that executes processing of converting commas to colons in stream conversion for which reading of the whole data is unnecessary, is the Any characteristic.

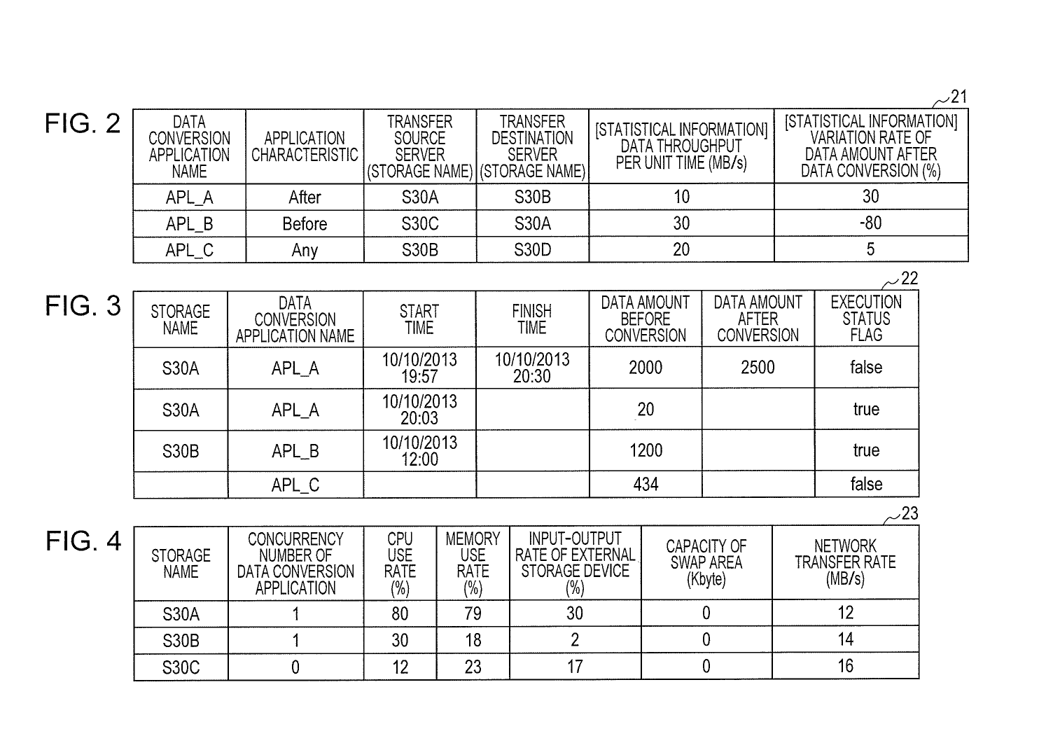

The data conversion application information management unit 11 accepts a data conversion application (program) which is registered by an operation of a user, and the meta information which is accompanied with the data conversion application, and stores the data conversion application in a predetermined storage area. Additionally, the data conversion application information management unit 11 stores the accepted meta information in a data conversion application information table 21 which is stored in the management DB 20. FIG. 2 illustrates an example of the data conversion application information table 21. In the example of FIG. 2, the name (data conversion application name) and the characteristic (application characteristic) are stored in association with each data conversion application. In the example of FIG. 2, the data conversion application information table 21 includes the statistical information of the data conversion application which will be described later.

Moreover, the statistical information management unit 12 obtains and manages the statistical information which is obtained by executing the data conversion application on each storage server 30. In the first embodiment, a data throughput per unit time for each data conversion application, and a variation rate of the data amount after the data conversion for each data conversion application, are used as statistical information.

The data throughput per unit time is statistical information that is used for considering, at the time of determining the storage server 30 which executes the data conversion, a characteristic indicating, for example, that the data conversion tends to take a long time even when the data throughput is small.

A variation rate of the data amount after the data conversion is statistical information that is used for considering, at the time of determining the storage server 30 which executes the data conversion, statistical data regarding the variation of data after the data conversion, which is unable to be specified by the characteristic of the data conversion application. Since a change in the variation of the data amount after the data conversion may occur due to the difference of target data even when the data conversion of the same type is performed, the variation rate of the data amount after the data conversion is used as a value in which an actual result value is reflected.

The statistical information management unit 12 obtains, from an execution instruction (will be described later in detail) of the data transfer which is accepted by the determination unit 14, the data conversion to be executed, the transfer source server S, and the information of transfer target data, and obtains, from the transfer source server S, the data amount of the transfer target data. When information on the data amount of the transfer target data is also included in the execution instruction, the information may be used. For example, the statistical information management unit 12 adds an entry of the data conversion application which is subjected to the execution instruction, to a data conversion application actual result table 22 as illustrated in FIG. 3. In the example of FIG. 3, each entry includes items of the name (storage name) of the storage server 30 which executes the data conversion application, start time of the data conversion, finish time, the data amount before the conversion, the data amount after the conversion, and an execution status flag. At a stage where the storage server 30 which executes the data conversion application is not yet determined, the statistical information management unit 12 sets the execution status flag at false, and stores the data amount of the obtained target data in the item of the data amount before the conversion.

When the storage server 30 which executes the data conversion application is determined by the determination unit 14 (will be described later in detail), the statistical information management unit 12 stores the name of the determined storage server 30 in the item of the storage name of the data conversion application actual result table 22. In addition, when the execution of the data conversion application is started by the storage server 30, the statistical information management unit 12 sets the execution status flag at true. Along therewith, every time the data conversion application is executed, the statistical information management unit 12 obtains the start time of the data conversion, the finish time, and the data amount after the conversion, and stores the obtained values in the items corresponding thereto. When the execution of the data conversion application is finished, the statistical information management unit 12 sets the execution status flag at false. When the contents of the entry are reflected in the statistical information which is stored in the data conversion application information table 21, the statistical information management unit 12 deletes the entry corresponding thereto.

Moreover, when the execution of the data conversion application is finished, the statistical information management unit 12 calculates execution time of each execution of the data conversion application from the difference between the start time and the finish time, with reference to the data conversion application actual result table 22. The statistical information management unit 12 adds up each of the calculated execution time and the data amount before the conversion corresponding thereto, to each of the execution time of the data conversion application which is executed in the past and the data amount before the conversion corresponding thereto. The statistical information management unit 12 calculates the data throughput per unit time for each data conversion application, based on the data amounts before the conversion which are added together/the execution time which is added together. Furthermore, the statistical information management unit 12 may calculate the data throughput per unit time for each execution of the data conversion application, and from an average of the calculated data throughput per unit time which have been calculated in the past, the statistical information management unit 12 may calculate the data throughput per unit time for each data conversion application.

Moreover, the statistical information management unit 12 obtains the variation rate of the data amount after the data conversion by calculating a formula of “(the data amount after the conversion−the data amount before the conversion)/the data amount before the conversion”, for each execution of the data conversion application, with reference to the data conversion application actual result table 22. The statistical information management unit 12 creates probability distribution of the variation rates of the data amount after the data conversion which is calculated with respect to each execution of the data conversion application. Therefore, the statistical information management unit 12 determines the variation rate of the data amount after the data conversion which has the largest probability in a range of the average value±standard deviation in the probability distribution, as a data variation rate for each data conversion application. Furthermore, the statistical information management unit 12 may calculate the variation rate of the data amount after the data conversion for each data conversion application, based on other statistical amounts, such as the average of the variation rates of the data amounts after the data conversion which are calculated for each execution of the data conversion application.

For example, the statistical information management unit 12 stores the calculated data throughput per unit time for each data conversion application, and the data variation rate after the data conversion for each data conversion application, in the data conversion application information table 21 illustrated in FIG. 2. In the example of FIG. 2, for each data conversion application, the data throughput per unit time, and the data variation rate after the data conversion of each data conversion application, are stored. As illustrated in FIG. 2, the information (storage name in the example of FIG. 2) identifying each of the transfer source server S and the transfer destination server R at the time of executing the data conversion application, may be further associated therewith. In this case, the data throughput per unit time, and the data variation rate after the data conversion of each data conversion application, are calculated with respect to each data conversion application, and each combination of the transfer source server S and the transfer destination server R.

The load information management unit 13 obtains and manages load information of each storage server 30. In a state that the load of the storage server 30 is large, it is expected that the time taken in the data conversion processing will increase. Therefore, the load information of the storage server 30 together with the statistical information of the data conversion application, are used at the time of determining the storage server 30 which executes the data conversion. In the first embodiment, a concurrency number of data conversion applications, and a resource use situation are used as load information.

The concurrency number of data conversion applications is the number of data conversion applications which are executed at a certain point of time, by each storage server 30. The resource use situation is a use situation of the resource at a certain point of time, by each storage server 30. For example, the resource use situations include a use rate of a CPU, a use rate of a memory, an input-output rate of an external storage device (disk), a capacity of a swap area, a network transfer rate and the like.

The load information management unit 13 periodically obtains the concurrency number of data conversion applications, by counting the number of data conversion applications being executed for each storage server 30, with reference to the data conversion application actual result table 22 which is managed by the statistical information management unit 12. Moreover, the load information management unit 13 periodically obtains each resource use situation, from each storage server 30. Then, the load information management unit 13 stores the obtained load information, in a load information table 23 which is stored in the management DB 20. FIG. 4 illustrates an example of the load information table 23. In the example of FIG. 4, the concurrency number of data conversion applications, and the resource use situation are stored in association with each storage server 30.

The determination unit 14 accepts the execution instruction of the data transfer which is accompanied with the data conversion between the storage servers 30, from a user or other processes. An execution instruction of data transfer is configured to designate, at least, the transfer source server S, the transfer destination server R, the target data, and the type of the data conversion. The determination unit 14 determines the storage server 30 which executes the data conversion, from the transfer source server S and the transfer destination server R which are designated in the execution instruction of the data transfer, so as to improve the efficiency of the data transfer, based on the information which is stored in each table of the management DB 20. Hereinafter, the storage server 30 which executes the data conversion is referred to as “data conversion execution server”.

The instruction unit 15 reads out, from the predetermined storage area, the data conversion application for performing the data conversion which is designated in the execution instruction of the data transfer, and transmits the read data conversion application to the data conversion execution server which is determined by the determination unit 14. According to the execution instruction of the data transfer, the instruction unit 15 notifies the storage server 30 which becomes the transfer source server S, of information on the target data of the data transfer and the transfer destination server R, as instruction information. Moreover, the instruction unit 15 gives the instruction of the acceptance of the data which is transferred from the transfer source server S, to the storage server 30 which becomes the transfer destination server R. When the data conversion execution server is the transfer source server S, the instruction unit 15 instructs the transfer source server S to perform data conversion of the data which is stored in the data conversion execution server. On the other hand, when the data conversion execution server is the transfer destination server R, the instruction unit 15 instructs the transfer destination server R to perform data conversion of the data which has been transferred from the transfer source server S.

In this way, when the data conversion execution server is the transfer source server S, the data conversion by the transfer source server S, and the transfer of the data from the transfer source server S to the transfer destination server R, are executed. When the data conversion execution server is the transfer destination server R, the data transfer from the transfer source server S to the transfer destination server R, and the data conversion by the transfer destination server R, are executed.

Next, the storage server 30 will be described. Since the storage server 30A and the storage server 30B have the same configurations, here, the storage server 30A will be described. The storage server 30A includes a data conversion application execution base 31, a data conversion application execution unit 32, and a transfer unit 33.

The data conversion application execution base 31 provides a base (called “Runtime”) for executing the data conversion application. The data conversion application execution unit 32 executes the data conversion application which is transmitted from the instruction unit 15. The transfer unit 33 performs the transfer (Sender) of the data, or the acceptance (Receiver) of the data, according to the instruction from the instruction unit 15.

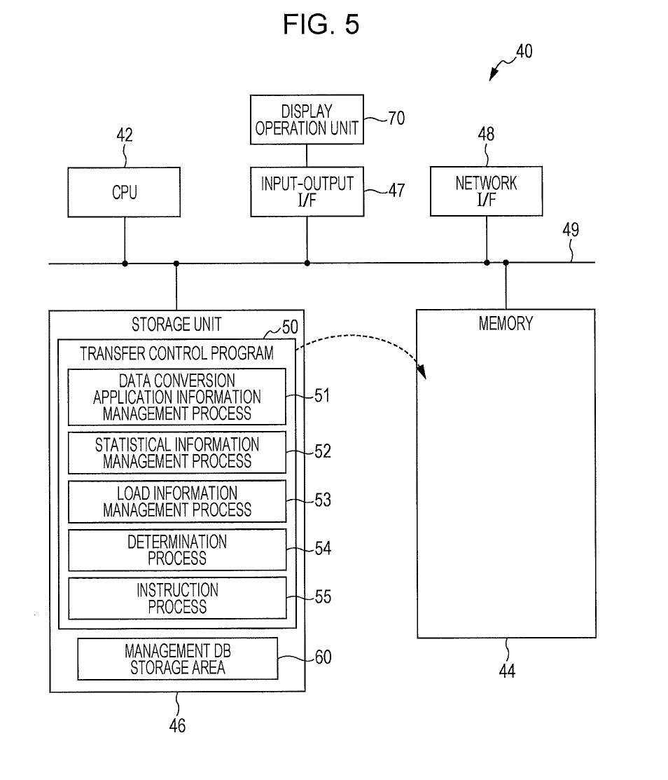

For example, the transfer control device 10 may be realized by a computer 40 illustrated in FIG. 5. The computer 40 includes a CPU 42, a memory 44, a nonvolatile storage unit 46, an input-output interface (I/F) 47, and a network I/F 48. The CPU 42, the memory 44, the storage unit 46, the input-output I/F 47, and the network I/F 48 are connected to each other through a bus 49. Additionally, a display operation unit 70, such as a display, a mouse, or a keyboard, is connected to the input-output I/F 47.

The storage unit 46 may be realized by a hard disk drive (HDD), a solid state drive (SSD), a flash memory or the like. In the storage unit 46 as a storage medium, a transfer control program 50 causing the computer 40 to function as a transfer control device 10 is stored. Moreover, the storage unit 46 includes a management DB storage area 60.

The CPU 42 loads the transfer control program 50 that has been read out from the storage unit 46, into the memory 44, and sequentially executes processes which are included in the transfer control program 50. Additionally, the CPU 42 reads out information which is stored in the management DB storage area 60, and load the information as each table illustrated in FIG. 2 to FIG. 4, into the memory 44.

The transfer control program 50 includes a data conversion application information management process 51, a statistical information management process 52, a load information management process 53, a determination process 54, and an instruction process 55. The CPU 42 operates as a data conversion application information management unit 11 illustrated in FIG. 1, by executing the data conversion application information management process 51. Further, the CPU 42 operates as a statistical information management unit 12 illustrated in FIG. 1, by executing the statistical information management process 52. The CPU 42 operates as a load information management unit 13 illustrated in FIG. 1, by executing the load information management process 53. Moreover, the CPU 42 operates as a determination unit 14 illustrated in FIG. 1, by executing the determination process 54. The CPU 42 operates as an instruction unit 15 illustrated in FIG. 1, by executing the instruction process 55. In this way, the computer 40 which executes the transfer control program 50, functions as a transfer control device 10.

For example, the transfer control device 10 may be realized by a semiconductor integrated circuit, more specifically, by an application specific integrated circuit (ASIC) or the like.

Moreover, the storage server 30 may be realized by the computer including the CPU, the memory, the nonvolatile storage unit, the input-output I/F, and the network I/F.

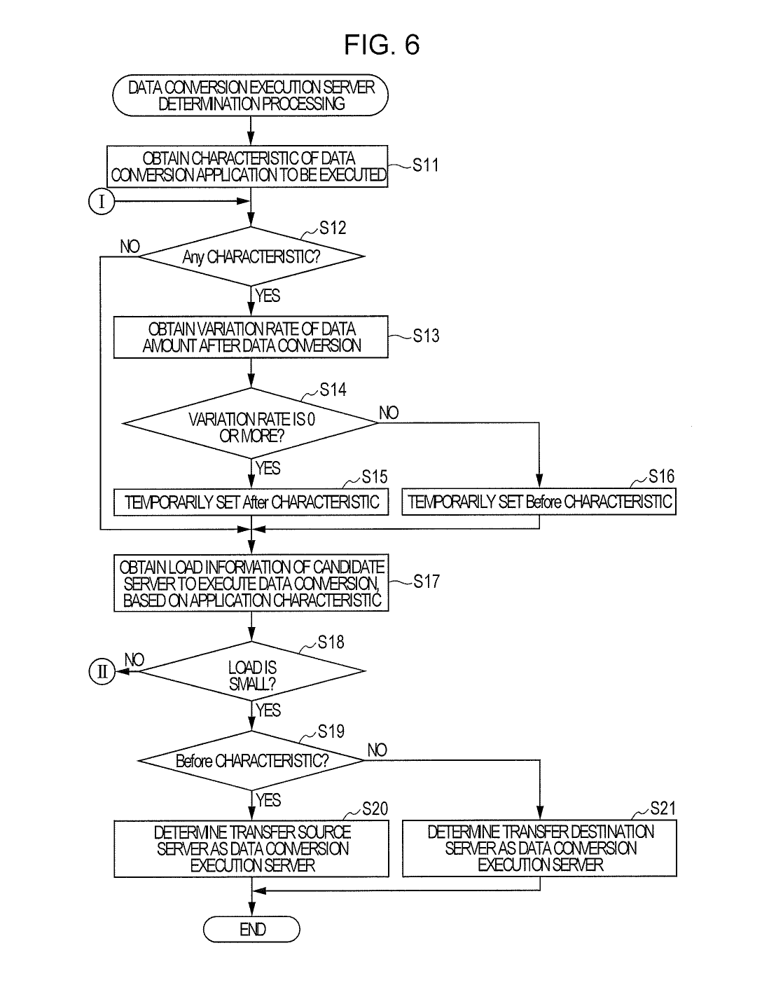

Next, the operations of the transfer control device 10 according to the first embodiment will be described. Upon receiving the execution instruction of the data transfer which is accompanied with the data conversion between the storage servers 30, from the user or other processes, the transfer control device 10 executes the data conversion execution server determination processing (will be described later in detail) illustrated in FIG. 6 to FIG. 8. The transfer control device 10 determines the data conversion execution server, by executing the data conversion execution server determination processing. The instruction unit 15 of the transfer control device 10, transmits the data conversion application to the determined data conversion execution server, and gives the instruction of the data conversion, according to the execution instruction of the data transfer. Further, the instruction unit 15 gives the instructions of the data transfer and the data reception to the storage servers 30 which become the transfer source server S and the transfer destination server R, according to the execution instruction of the data transfer.

The statistical information management unit 12 adds an entry to the data conversion application actual result table 22, based on the information obtained from the execution instruction of the data transfer, and manages the actual result data which is obtained by executing the data conversion application. Moreover, the statistical information management unit 12 obtains the statistical information of each data conversion application, with reference to the data conversion application actual result table 22, and manages the obtained statistical information by storing the same in the data conversion application information table 21.

Additionally, the load information management unit 13 periodically obtains the load information from the storage server 30 while each storage server 30 operates, and manages the obtained load information by storing the same in the load information table 23.

Moreover, when the data conversion application and the meta information are registered by a user, the data conversion application information management unit 11 accepts the data conversion application and the meta information. The data conversion application information management unit 11 manages the data conversion application and the meta information by storing the accepted data conversion application in the predetermined storage area, and by storing the meta information in the data conversion application information table 21.

Here, the data conversion execution server determination processing which is executed by the transfer control device 10, will be described with reference to FIG. 6 to FIG. 8. Here, a case of determining a data conversion execution server by using the information which is stored in each table illustrated in FIG. 2 to FIG. 4, will be described. Additionally, the transfer source server S which is designated by the execution instruction of the data transfer, is assumed to be the storage server 30A (storage name: S30A), and the transfer destination server R is assumed to be the storage server 30B (storage name: S30B).

First, in step S11 of FIG. 6, the determination unit 14 obtains a characteristic corresponding to the data conversion application for executing the data conversion which is designated by the execution instruction of the accepted data transfer, from the data conversion application information table 21. For example, when the data conversion application is “APL_A”, the After characteristic is obtained as a characteristic corresponding to the data conversion application.

Next, in step S12, the determination unit 14 determines whether the characteristic of the data conversion application is the Any characteristic. In the case of the Any characteristic, the processing shifts to step S13, and in the case of the Before characteristic or the After characteristic, the processing shifts to step S17.

In step S13, the determination unit 14 obtains the variation rate of the data amount after the data conversion corresponding to the data conversion application, from the data conversion application information table 21. Next, in step S14, the determination unit 14 determines whether the obtained variation rate is 0 or more. When the variation rate is 0 or more, it is expected that the data amount tends to increase after the data conversion, and the processing shifts to step S15 in which the determination unit 14 temporarily sets the After characteristic as a characteristic of the data conversion application. On the other hand, when the variation rate is less than 0, it is expected that the data amount tends to decrease after the data conversion, and the processing shifts to step S16 in which the determination unit 14 temporarily sets the Before characteristic, as a characteristic of the data conversion application. For example, when the data conversion application is “APL_C”, since the variation rate is “5” which is 0 or more, the After characteristic is temporarily set as a characteristic of the data conversion application.

In the following processing, the characteristic that is temporarily set in step S15 or S16, is used in data conversion application whose characteristic managed by the data conversion application information table 21 is the Any characteristic.

Next, in step S17, the determination unit 14 obtains the load information of a candidate for the data conversion execution server, from the load information table 23, based on the characteristic of the data conversion application. Specifically, when the characteristic of the data conversion application is the Before characteristic, the transfer source server S is a candidate for the data conversion execution server. On the other hand, when the characteristic of the data conversion application is the After characteristic, the transfer destination server R is a candidate for the data conversion execution server. The determination unit 14 specifies a candidate for the data conversion execution server, based on the characteristic of the data conversion application and the information on the transfer source server S and the transfer destination server R which are designated by the execution instruction of the data transfer. For example, when the data conversion application is “APL_B”, since the characteristic of “APL_B” is the Before characteristic, the storage server 30A that is the transfer source server S which is designated by the execution instruction of the data transfer, is specified as a candidate. The determination unit 14 obtains the load information which is associated with the specified candidate for the data conversion execution server, with reference to the load information table 23.

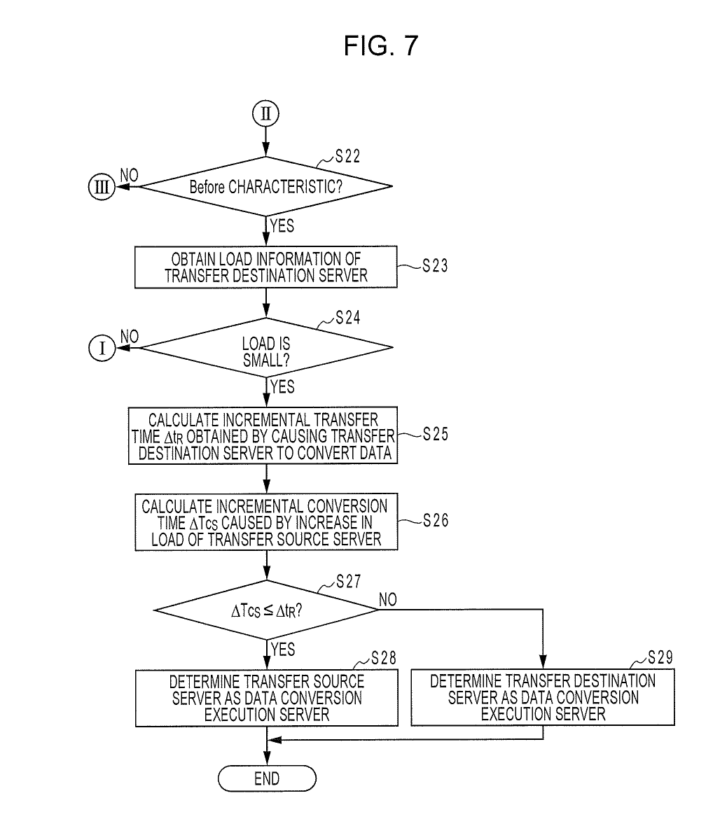

Next, in step S18, based on the obtained load information, it is determined whether the load situation is small or not, by determining whether the load situation of the candidate of the data conversion execution server satisfies a predetermined condition or not. For example, the predetermined condition may be set such that the load situation is determined to be small when the concurrency number of data conversion applications is a predetermined number or less and the resource use situation is a predetermined value or less. The case where the resource use situation is the predetermined value or less, may be defined as a case where each of all the resource use situations is equal to or less than a threshold which is determined for the each resource. Furthermore, the condition is not limited to the above example. When the determination unit 14 has determined that the load situation of the candidate for the data conversion execution server is small, by comparing the load information with the condition, the processing shifts to step S19, and, when the determination unit 14 has determined that the load situation is large, the processing shifts to step S22 of FIG. 7.

In step S19, the determination unit 14 determines whether or not the characteristic of the data conversion application is the Before characteristic. In the case of the Before characteristic, the processing shifts to step S20 in which the determination unit 14 determines the transfer source server S (here, the storage server 30A) which is the candidate for the data conversion execution server, as the data conversion execution server. On the other hand, when the characteristic of the data conversion application is the After characteristic, the processing shifts to step S21 in which the determination unit 14 determines the transfer destination server R (here, the storage server 30B) which is the candidate for the data conversion execution server, as the data conversion execution server.

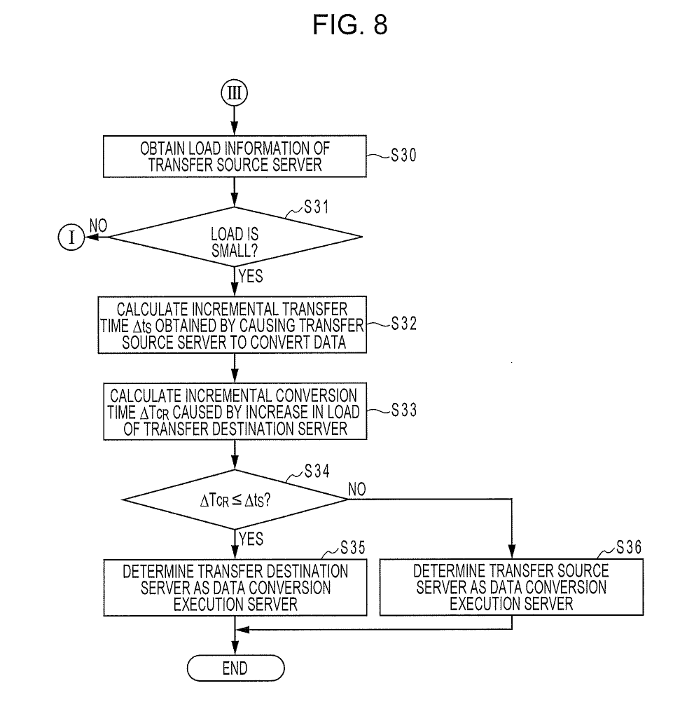

When the processing shifts to step S22 by determining NO in step S18, the determination unit 14 determines whether or not the characteristic of the data conversion application is the Before characteristic. In the case of the Before characteristic, the processing shifts to step S23, and in the case of the After characteristic, the processing shifts to step S30 of FIG. 8.

In step S23, the determination unit 14 obtains the load information of the transfer destination server R which is not the candidate for the data conversion execution server, from the load information table 23. Next, in step S24, by comparing the load situation which is indicated by the obtained load information with the predetermined condition in the same manner as step S18, the determination unit 14 determines whether or not the load situation of the transfer destination server R is small. When the load situation is small, the processing shifts to step S25, and when the load situation is large, the processing returns to step S12 of FIG. 6.

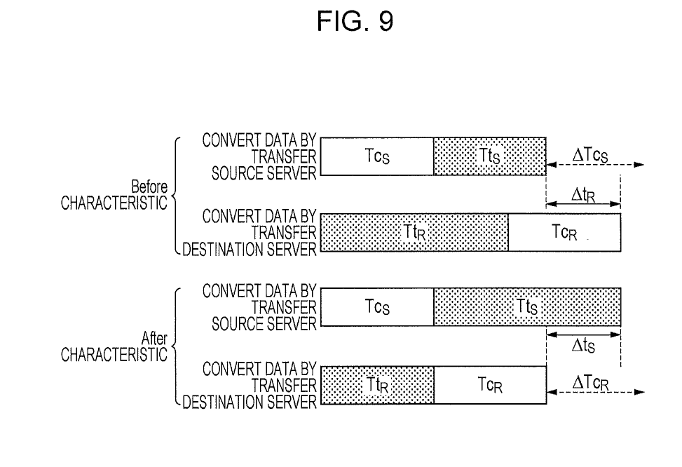

In step S25, an incremental transfer time Δt_{R} that is a time increased by causing the transfer destination server R to convert the data, is calculated. Here, as illustrated in FIG. 9, a conversion time which is taken for the transfer source server S to convert the data is referred to as Tc_{S}, and a conversion time which is taken for the transfer destination server R to convert the data is referred to as Tc_{R}. Moreover, the transfer time of the data in the first case of converting the data by the transfer source server S is referred to as Tt_{S}, and the transfer time of the data in the second case of converting the data by the transfer destination server R is referred to as Tt_{R}. In FIG. 9, in order to simplify the description, Tc_{S}=Tc_{R} is assumed. When the characteristic of the data conversion application is the Before characteristic, the relationship between transfer times of the first and second cases is Tt_{S}<Tt_{R}. Therefore, the difference of the times, taken for the entire data transfer including the data conversion, between the first and second cases, is the incremental transfer time Δt_{R} that is an increment of the transfer time obtained by causing the transfer destination server R in the Before characteristic to convert the data.

The determination unit 14 obtains the data amount (data amount before the conversion) of the target data, with reference to the data conversion application actual result table 22. Moreover, the determination unit 14 obtains the variation rate of the data amount after the data conversion corresponding to the data conversion application, from the data conversion application information table 21. AS for the data conversion application without the actual result which is actually executed, since the statistical information thereof is not accumulated, the predetermined variation rate is used depending on the characteristic of the data conversion application. Furthermore, the determination unit 14 obtains the network transfer rate corresponding to the transfer source server S, from the load information table 23, and the determination unit 14 calculates the incremental transfer time Δt_{R}, by the following equation (1).

Δt_{R}=(Tt_{R}+Tc_{R})−(Tc_{S}+Tt_{S})=(the data amount of the target data×the network transfer rate)−(the data amount of the target data (1+the variation rate)×the network transfer rate) (1)

### Here, Tc_{R}=Tc_{S}

Next, in step S26, the determination unit 14 calculates the incremental conversion time ΔTc_{S} that is an increment of the conversion time Tc_{S} resulting from increase in the load of the transfer source server S. Specifically, the determination unit 14 obtains the data throughput per unit time corresponding to the data conversion application, from the data conversion application information table 21. As for the data conversion application without the actual result which is actually executed, since the statistical information thereof is not accumulated, a predetermined data throughput per unit time is used depending on the characteristic of the data conversion application. Moreover, the determination unit 14 obtains each resource use situation corresponding to the transfer source server S, from the load information table 23, and obtains a coefficient k depending on the load situation of the transfer destination server R indicating each resource use situation, based on a predetermined correspondence relationship between the load situation and the coefficient k. For example, in the case of setting k at 1 for an initial conversion time that is required when the load situation of the storage server 30 is small (satisfies the condition), k times the initial conversion time may be set as a conversion time for each load situation. Furthermore, the load situation corresponding to the coefficient k, is not limited to the value using all the resource use situations, and for example, may be a value using only the use rate of the CPU. Therefore, the determination unit 14 calculates the incremental conversion time ΔTc_{S}, by the following equation (2).

ΔTc_{S}=(k−1)×Tc_{S}=(k−1)×(the data throughput per unit time×the data amount of the target data) (2)

Next, in step S27, the determination unit 14 determines whether or not the incremental conversion time ΔTc_{S} calculated in step S26 is equal to or less than the incremental transfer time Δt_{R} calculated in step S25. Here, as illustrated in FIG. 9, even when the characteristic of the data conversion application is the Before characteristic, in a case where ΔTc_{S}>Δt_{R} since the load situation of the transfer source server S is large, the efficiency may be improved by causing the transfer destination server R to convert the data. Therefore, in a case of ΔTc_{S}≦Δt_{R}, the processing shifts to step S28, and the determination unit 14 determines the transfer source server S (here, the storage server 30A) as the data conversion execution server. On the other hand, in the case of ΔTc_{S}>Δt_{R}, the processing shifts to step S29, and the determination unit 14 determines the transfer destination server R (here, the storage server 30B) as the data conversion execution server.

When the processing shifts to step S30 of FIG. 8 by determining NO in step S22, the determination unit 14 obtains the load information of the transfer source server S which is not a candidate for the data conversion execution server, from the load information table 23. Next, in step S31, by comparing the load situation indicating the obtained load information with a predetermined condition in the same manner as step S18, the determination unit 14 determines whether or not the load situation of the transfer source server S is small. When the load situation is small, the processing shifts to step S32, and when the load situation is large, the processing returns to step S12 of FIG. 6.

In step S32, an incremental transfer time Δt_{S} obtained by causing the transfer source server S to convert the data is calculated. As illustrated in FIG. 9, when the characteristic of the data conversion application is the After characteristic, a relationship between the transfer times is Tt_{R}<Tt_{S}. The difference of the times that is required for the entire data transfer including the above data conversion is the incremental transfer time Δt_{S} by causing the transfer source server S in the After characteristic to convert the data.

The determination unit 14 calculates the incremental transfer time Δt_{S}, by the following equation (3), using the data amount of the target data which is obtained in step S25, the variation rate of the data amount after the data conversion corresponding to the data conversion application, and the network transfer rate corresponding to the transfer source server S.

Δt_{S}=(Tc_{S}+Tt_{S})−(Tt_{R}+Tc_{R})=(the data amount of the target data (1+the variation rate)×the network transfer rate)−(the data amount of the target data×the network transfer rate) (3)

### Here, Tc_{R}=Tc_{S}

Next, in step S33, the determination unit 14 calculates the incremental conversion time ΔTc_{R} caused by increase in the load of the transfer destination server R. Specifically, the determination unit 14 obtains each resource use situation corresponding to the transfer destination server R, from the load information table 23, and obtains the coefficient k depending on the load situation of the transfer destination server R which is indicated by each resource use situation, based on the predetermined correspondence relationship between the load situation and the coefficient k. The determination unit 14 calculates the incremental conversion time ΔTc_{R}, by the following equation (4).

ΔTc_{R}=(k−1)×Tc_{R}=(k−1)×(the data throughput per unit time×the data amount of the target data) (4)

Next, in step S34, the determination unit 14 determines whether or not the incremental conversion time ΔTc_{R} calculated in step S33 is equal to or less than the incremental transfer time Δt_{S} calculated in step S32. Here, as illustrated in FIG. 9, even when the characteristic of the data conversion application is the After characteristic, in a case where ΔTc_{R}>Δt_{S} since the load situation of the transfer destination server R is large, the efficiency may be improved in the case of converting the data by the transfer source server S. Therefore, in a case of ΔTc_{R}≦Δt_{S}, the processing shifts to step S35, and the determination unit 14 determines the transfer destination server R (here, the storage server 30B) as the data conversion execution server. On the other hand, in the case of ΔTc_{R}>Δt_{S}, the processing shifts to step S36, and the determination unit 14 determines the transfer source server S (here, the storage server 30A) as the data conversion execution server.

The case of determining NO in step S24 or S31 is a case that the load situations of all of the transfer source server S and the transfer destination server R are large. In this case, by returning to step S12, the determination of the data conversion execution server is suspended. When the load situation of any one of the transfer source server S and the transfer destination server R becomes small while returning to step S12 and repeating the processes after step S13, the data conversion execution server is determined. Furthermore, at the time of returning to step S12 by determining NO in step S24 or S31, a predetermined standby time may be set.

As described above, according to the transfer control device 10 relating to the first embodiment, the characteristic indicating the variation in data amount before and after the data conversion for the data conversion application to be executed, the statistical information at the time of executing the data conversion application, and the load information of the storage server, are managed. Then, the candidate for the data conversion execution server is specified, based on the characteristic of the data conversion application. Based on the load information, the load situation of the candidate is determined, and when the load situation indicates a small load, the candidate is determined as a data conversion execution server. Additionally, when the load situation of the candidate indicates a large load, and the load situation of the storage server which is not the candidate indicates a small load, the storage server whose efficiency is better is determined as a data conversion execution server, by comparing the efficiencies of the data transfer in both of the statistical information and the load information, based on the statistical information and the load information. Hereby, it is possible to improve the data transfer efficiency of the data transfer which is accompanied with the data conversion between the storage servers.

### Second Embodiment

Next, a second embodiment will be described. Since a configuration of a transfer control device 10 according to the second embodiment is the same as the transfer control device 10 according to the first embodiment, the description thereof will be omitted.

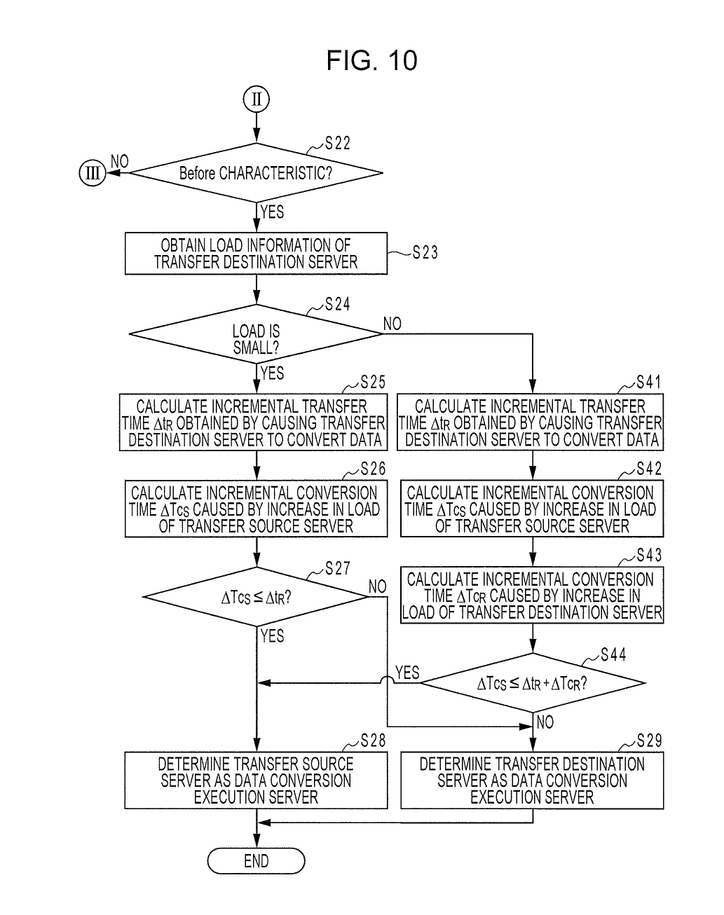

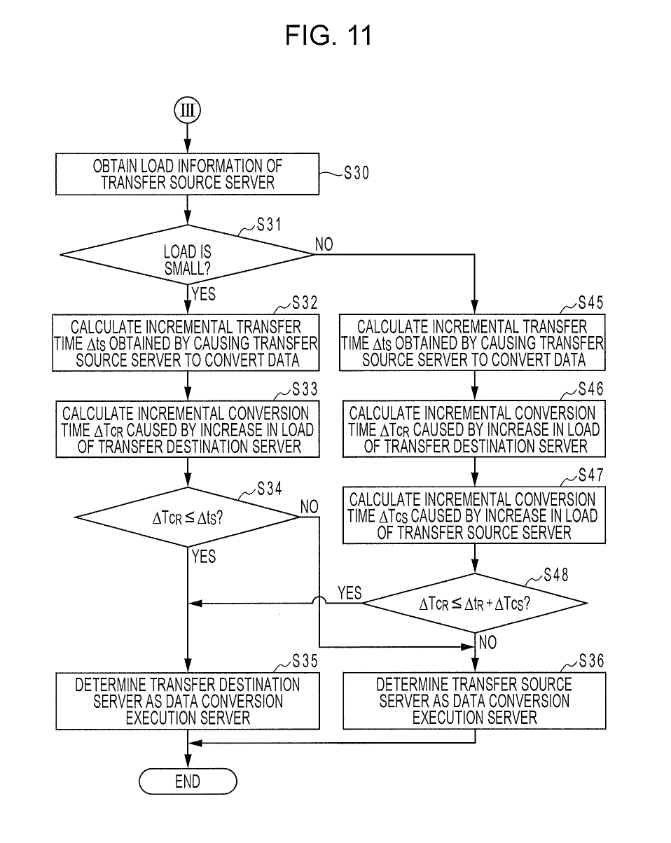

In the first embodiment, it is described the case that the determination of the data conversion execution server is suspended when the load situations of both the transfer source server S and the transfer destination server R are large. In the second embodiment, even when the load situations of both the transfer source server S and the transfer destination server R are large, by comparing the efficiencies of the data transfer in both the transfer source server S and the transfer destination server R, the storage server whose efficiency is better is determined as a data conversion execution server. Hereinafter, with reference to FIG. 10 and FIG. 11, in the data conversion execution server determination processing of the second embodiment, items which are different from the data conversion execution server determination processing of the first embodiment will be described.

In a case of determining NO in step S24 of FIG. 10, the processing shifts to step S41, and the determination unit 14 calculates the incremental transfer time Δt_{R} obtained by causing the transfer destination server R to convert the data, in the same manner as step S25. Next, in step S42, the determination unit 14 calculates the incremental conversion time ΔTc_{S} caused by increase in the load of the transfer source server S, in the same manner as step S26.

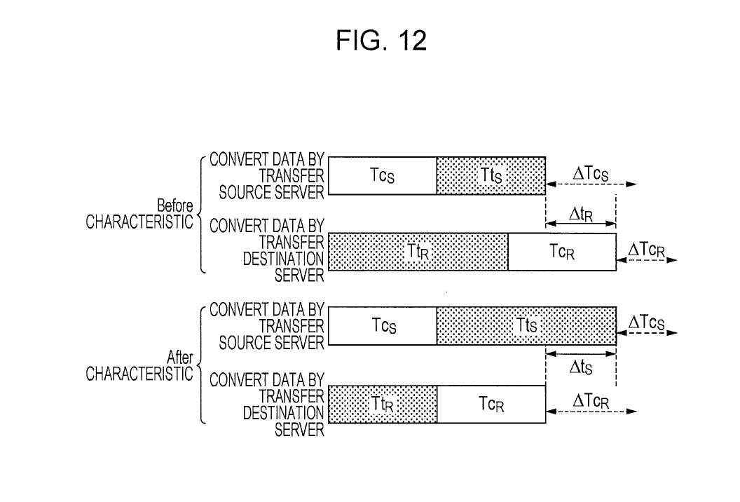

Next, in step S43, the determination unit 14 calculates the incremental conversion time ΔTc_{R} caused by increase in the load of the transfer destination server R, in the same manner as step S33. As illustrated in FIG. 12, when the characteristic of the data conversion application is the Before characteristic, when the load of both the transfer source server S and the transfer destination server R are large, the difference between the data transfer time of the transfer source server S and the data transfer time of the transfer destination server R is represented by the difference between ΔTc_{S} and (Δt_{R}+ΔTc_{R}). Therefore, in the following step S44, the determination unit 14 determines whether or not ΔTc_{S}≦(Δt_{R}+ΔTc_{R}). When ΔTc_{S}≦(Δt_{R}+ΔTc_{R}), the processing shifts to step S28, and the determination unit 14 determines the transfer source server S (here, the storage server 30A) as the data conversion execution server. On the other hand, when ΔTc_{S}>(Δt_{R}+ΔTc_{R}), the processing shifts to step S29, and the determination unit 14 determines the transfer destination server R (here, the storage server 30B) as the data conversion execution server.

Moreover, in a case of determining NO in step S31 of FIG. 11, the processing shifts to step S45, and the determination unit 14 calculates the incremental transfer time Δt_{S} obtained by causing the transfer source server S to convert the data, in the same manner as step S32. Next, in step S46, the determination unit 14 calculates the incremental conversion time ΔTc_{R} caused by increase in the load of the transfer destination server R, in the same manner as step S33.

Next, in step S47, the determination unit 14 calculates the incremental conversion time ΔTc_{S} caused by increase in the load of the transfer source server S, in the same manner as step S26. As illustrated in FIG. 12, in a case where the characteristic of the data conversion application is the After characteristic, when the loads of both the transfer source server S and the transfer destination server R are large, the difference between the data transfer time of the transfer source server S and the data transfer time of the transfer destination server R is represented by the difference between ΔTc_{R} and (Δt_{S}+ΔTc_{S}). Therefore, in the following step S48, the determination unit 14 determines whether or not ΔTc_{R}≦(Δt_{S}+ΔTc_{S}). When ΔTc_{R}≦(Δt_{S}+ΔTc_{S}), the processing shifts to step S35, and the determination unit 14 determines the transfer destination server R (here, the storage server 30B) as the data conversion execution server. On the other hand, when ΔTc_{R}>(Δt_{S}+ΔTc_{S}), the processing shifts to step S36, and the determination unit 14 determines the transfer source server S (here, the storage server 30A) as the data conversion execution server.

As described above, according to the transfer control device 10 relating to the second embodiment, even when the loads of both the transfer source server S and the transfer destination server R are large, the storage server whose efficiency is better is determined as a data conversion execution server, by comparing the efficiencies of the data transfer in both the transfer source server S and the transfer destination server R. Hereby, it is possible to improve the data transfer efficiency of the data transfer which is accompanied with the data conversion between the storage servers, in the same manner as the first embodiment.

In the above embodiments, a form in which the transfer control program 50 is stored (installed) in advance in the storage unit 46 is described, but it is not limited thereto. It is possible to provide a form of recording the transfer control program 50 in the storage medium such as a CD-ROM, a DVD-ROM, a USB memory or the like.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory, computer-readable recording medium having stored therein a program for causing a computer to execute a process, the process comprising:
in a case of executing, on transfer data which is to be transferred from a first information processing device to a second information processing device, data processing that complies with a data storage format in the second information processing device, determining, as a target information processing device for executing the data processing, one of the first and second information processing devices, based on information on the data processing which includes a variation characteristic of data amount before and after the data processing.

2. The non-transitory, computer-readable recording medium of claim 1, wherein
the process further comprises:
determining the variation characteristic corresponding to the data processing on the transfer data, based on correspondence information stored in a storage unit, the correspondence information storing a variation characteristic in association with each of types of the data processing; and
determining, as the target information processing device, one of the first and second information processing devices, based on the determined variation characteristic.

3. The non-transitory, computer-readable recording medium of claim 2, wherein
the process further comprises:
obtaining load information of the first and second information processing devices, and statistical information obtained from actual results of executing the data processing in each of the first and second information processing devices;
determining, as the target information processing device, one of the first and second information processing devices whose load situation satisfies a predetermined condition and by which a time taken for transferring data and executing the data processing on the transfer data becomes shorter, based on the obtained load information and the obtained statistical information; and
when the load situation of none of the first and second information processing devices satisfies the predetermined condition, suspending the determining the target information processing device for a predetermined time.

4. The non-transitory, computer-readable recording medium of claim 2, wherein
the process further comprises:
obtaining load information of the first and second information processing devices, and statistical information obtained from actual results of executing the data processing in each of the first and second information processing devices;
determining, as a target information processing device for executing the data processing, one of the first and second information processing devices whose load situation satisfies a predetermined condition and by which a time taken for transferring the transfer data and executing the data processing on the transfer data becomes shorter, based on the obtained load information and the obtained statistical information; and
when the load situation of none of the first and second information processing devices satisfies the predetermined condition, determining, as the target information processing device, one of the first and second information processing devices by which a time taken for transferring the transfer data and executing the data processing on the transfer data becomes shorter, based on the obtained load information and the obtained statistical information.

5. The non-transitory, computer-readable recording medium of claim 1, wherein
the process further comprises transmitting a program for executing the data processing, to the target information processing device.

6. A transfer control method comprising:
in a case of executing, on transfer data which is to be transferred from a first information processing device to a second information processing device, data processing that complies with a data storage format in the second information processing device, causing a computer to determine, as a target information processing device for executing the data processing, one of the first and second information processing devices, based on information on the data processing which includes a variation characteristic of data amount before and after the data processing.

7. The transfer control method of claim 6, further comprising causing the computer:
to determine the variation characteristic corresponding to the data processing on the transfer data, based on correspondence information stored in a storage unit, the correspondence information storing a variation characteristic in association with each of types of the data processing; and
to determine, as the target information processing device, one of the first and second information processing devices, based on the determined variation characteristic.

8. The transfer control method according to claim 7, further comprising causing the computer:
to obtain load information of the first and second information processing devices, and statistical information obtained from actual results of executing the data processing in each of the first and second information processing devices;
to determine, as the target information processing device, one of the first and second information processing devices whose load situation satisfies a predetermined condition and by which a time taken for transferring data and executing the data processing on the transfer data becomes shorter, based on the obtained load information and the obtained statistical information; and
to suspend, when the load situation of none of the first and second information processing devices satisfies the predetermined condition, determining the target information processing device for a predetermined time.

9. The transfer control method according to claim 7, further comprising causing the computer:
to obtain load information of the first and second information processing devices, and statistical information obtained from actual results of executing the data processing in each of the first and second information processing devices;
to determine, as a target information processing device for executing the data processing, one of the first and second information processing devices whose load situation satisfies a predetermined condition and by which a time taken for transferring the transfer data and executing the data processing on the transfer data becomes shorter, based on the obtained load information and the obtained statistical information; and
to determine, when the load situation of none of the first and second information processing devices satisfies the predetermined condition, as the target information processing device, one of the first and second information processing devices by which a time taken for transferring the transfer data and executing the data processing on the transfer data becomes shorter, based on the obtained load information and the obtained statistical information.

10. The transfer control method of claim 6, further comprising causing the computer to transmit a program for executing the data processing, to the target information processing device.

11. A transfer control device comprising:
a processor configured to determine, in a case of executing, on transfer data which is to be transferred from a first information processing device to a second information processing device, data processing that complies with a data storage format in the second information processing device, as a target information processing device for executing the data processing, one of the first and second information processing devices, based on information on the data processing which includes a variation characteristic of data amount before and after the data processing; and
a memory coupled to the processor, the memory being configured to store the information on the data processing.

12. The transfer control device of claim 11, wherein
the processor is further configured:
to determine the variation characteristic corresponding to the data processing on the transfer data, based on correspondence information stored in a storage unit, the correspondence information storing a variation characteristic in association with each of types of the data processing; and
to determine, as the target information processing device, one of the first and second information processing devices, based on the determined variation characteristic.

13. The transfer control device of claim 12, wherein
the processor is further configured:
to obtain load information of the first and second information processing devices, and statistical information obtained from actual results of executing the data processing in each of the first and second information processing devices;
to determine, as the target information processing device, one of the first and second information processing devices whose load situation satisfies a predetermined condition and by which a time taken for transferring data and executing the data processing on the transfer data becomes shorter, based on the obtained load information and the obtained statistical information; and
to suspend, when the load situation of none of the first and second information processing devices satisfies the predetermined condition, determining the target information processing device for a predetermined time.

14. The transfer control device of claim 12, wherein
the processor is further configured:
to obtain load information of the first and second information processing devices, and statistical information obtained from actual results of executing the data processing in each of the first and second information processing devices;
to determine, as a target information processing device for executing the data processing, one of the first and second information processing devices whose load situation satisfies a predetermined condition and by which a time taken for transferring the transfer data and executing the data processing on the transfer data becomes shorter, based on the obtained load information and the obtained statistical information; and
to determine, when the load situation of none of the first and second information processing devices satisfies the predetermined condition, as the target information processing device, one of the first and second information processing devices by which a time taken for transferring the transfer data and executing the data processing on the transfer data becomes shorter, based on the obtained load information and the obtained statistical information.

15. The transfer control device of claim 11, wherein
the processor is further configured to transmit a program for executing the data processing, to the target information processing device.
